(19) United States
(12) Patent Application Publication
(10) Pub. No.: US 2010/0047509 A1
(43) Pub. Date: Feb. 25, 2010

(54) ORGANIC DYE COMPOUND AND HIGH DENSITY OPTICAL RECORDING MEDIUM INCLUDING THE SAME

(75) Inventors: Shin-Shin Wang, Hsinchu City (TW); Arumugam Balasubramanian, Hsinchu City (TW); Chien-Liang Huang, Taoyuan County (TW); Chung-Ta Cheng, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: Industrial Technology Research Institute, Hsinchu (TW)

(21) Appl. No.: 12/183,049

(22) Filed: Jul. 30, 2008

(51) Int. Cl. B32B 3/02; C07F 15/06

(52) U.S. Cl. 428/64.9; 548/105; 428/64.8

(57) ABSTRACT

A recording layer including a novel organic dye compound (I) for a high density optical recording medium is provided. The organic dye compound (I) has the following general chemical structural formula:

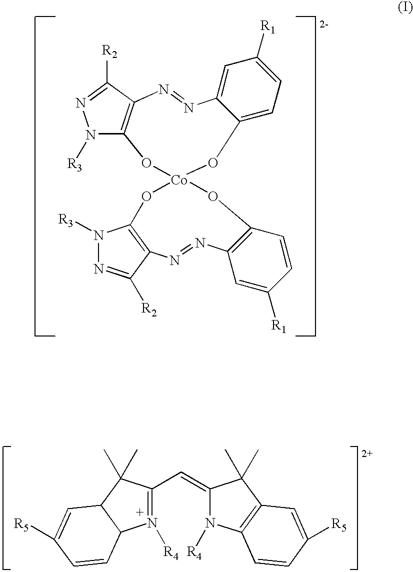

wherein R₁, R₂, R₃, R₄ and R₅ each independently represent H, alkyl, halide, nitro, benzyl group or substituted benzyl group. The organic dye compound (I) exhibits a maximum absorbance at a wavelength range of 400-550 nm.

### BACKGROUND OF THE INVENTION

1. Field of the Invention

The present invention generally relates to an optical recording medium. More particularly, the present invention relates to organic dye compound and an optical recording medium including the same.

2. Description of Related Art

Organic dye compounds are popularly used for fabricating organic optical recording media because of their advantages of low cost and excellent recording characteristics. In recent years, development of optical recording media employing laser have been remarkable. An example of the optical recording medium, such as an optical disc, is generally designed to irradiate a focused laser beam of about 1 μm to a thin recording layer formed on a disc shaped substrate to conduct information recording. The recording is implemented in a manner that upon absorption of the laser beam energy, the irradiated portion of the recording layer undergoes a thermal deformation such as decomposition, evaporation or melting. Reading the difference in the reflectance between the portion having a deformation formed by the laser beam and the portion without such deformation carries out reproduction of the recorded information. Accordingly, an optical recording medium is required to efficiently absorb the energy of the laser beam, and is also required to have a predetermined amount of absorbed light to a laser beam having a specific wavelength employed for recording and to be high in the reflectance to laser beam having a specific wavelength employed for reproduction for accurately conducting the reproduction of information.

Japanese patent JP 2007216439 belonging to Mitsubishi discloses the use of a metal complex including hydrazone ligand having a following general chemical structural formula for making the recording layer.

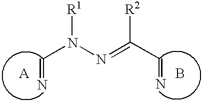

Japanese patent JP2007196661 belonging to Mitsubishi discloses the use of a following organic dye for making the recording layer.

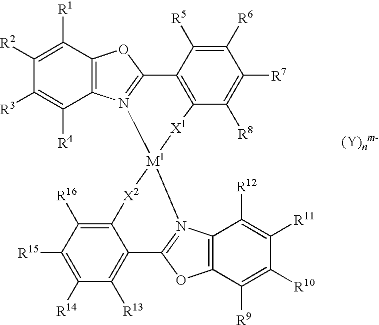

International patent publication WO2006061398 belonging to Clariant discloses the use of azo metal dyes of pyridine N-oxide having a following general chemical structural formula for making the recording layer.

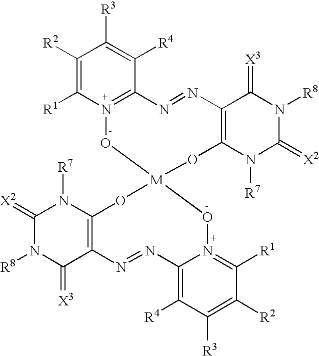

European patent publication EP 1517316 belonging to Clariant discloses the use of a following azo type dye having a general chemical structural formula for making the recording layer.

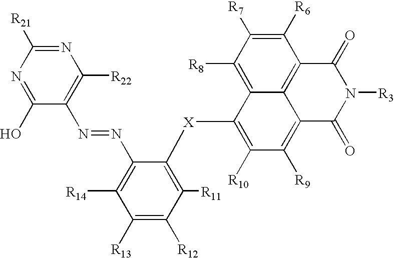

In the present multimedia age, optical recording media such as CD-R (a write-once memory using compact disc) and DVD-R (a write-once memory using digital video disc) are now of great importance. Presently available high density television (HD-TV) is capable of storing two hours of digital information, memory has a storage capacity of about 15-50 GB, CD-R has a recording capacity of up to 650 MB and DVD-R has a recording capacity up to 4.7 GB, which is not sufficient for the ever increasing present demand to record movie and animations for six hours in image quality of standard television or for two hours even in relatively-high image quality of high definition television.

Some principles and methods of enhancement of the storage density of the optical information storage media include such as shifting of the wavelength of the laser source, for example, from red laser to blue laser, or enhancement of the objective numerical aperture (“NA”) of optical lens. Some other methods include improvement of the encoding methods of the digital signal, or a disc storage method using an extra-fine resolution near field optical structure, or a teclimology for increasing the storage capacity of the information storage media (e.g., a compact disc) by using stacked multiple recording layers, i.e., the recording layers of the information storage media is developed into a three dimensional space multilayer structure, to increase the storage capacity. All the methods described above may be employed to effectively increase the storage capacity of the optical recording medium.

However, since most organic dye compounds used in the conventional optical recording media cannot be used with visible light with a wavelength of 450 nm or less, they can not fulfill the need for high-storage density requirement. Therefore, if new organic dye compounds that can be used with visible light with a wavelength of 450 nm or less, it would be possible to significantly promote the recording capacity of the organic optical recording media. For example, a single-side Blue-ray Disc may be promoted up to 15 GB by employing a 405 nm blue laser source and a 0.01 mm optical transmission cover layer structure.

Thus, it is highly desirable to provide new organic dye compounds that exhibit excellent recording properties, such as exhibiting maximum absorbance at visible light with a wavelength of about 450 nm, excellent light fastness and light resistance, and better chemical and thermal stabilities.

### SUMMARY OF THE INVENTION

Accordingly, the present invention is directed to an organic dye compound (I) suitable for making a recording layer that allows recording of information employing a short wavelength laser source and exhibit good write characteristics and compatible with the write-once recording medium.

According to an embodiment of the present invention, the anionic moiety of the organic dye compound (I) may enhance the recording properties, such as light fastness and light resistance, and chemical and thermal stabilities.

The present invention is also directed to an optical storage medium including a recording layer comprising the organic dye compound (I) for recording information and storing the recorded information such that good write characteristics and the compatibility with the write-once recording medium may be retained. The recording layer comprising the organic dye compound (I) exhibits excellent recording properties, such as exhibiting maximum absorbance at visible light with a shorter wavelength of 400 nm or 550, excellent light fastness and light resistance, and better chemical and thermal stabilities.

According to an embodiment of the present invention, the organic dye compound (I) comprise the following general chemical structural formulae, respectively:

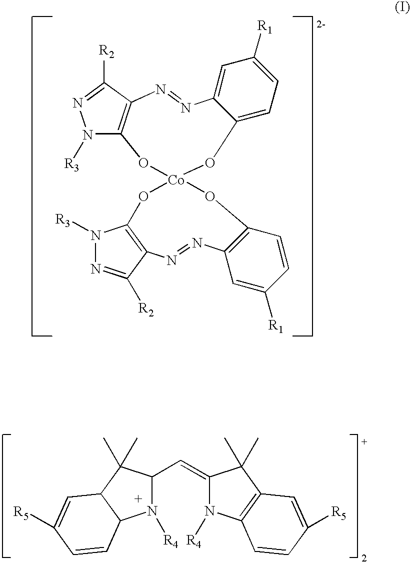

wherein R₁, R₂, R₃, R₄ and R₅ each independently represent H, alkyl, halide, nitro, benzyl group or substituted benzyl group. The above organic dye compound (I) exhibits the maximum absorbance at wavelength within a range of 400 to 550 nm, excellent light fastness and light resistance, and better chemical and thermal stabilities.

According to an embodiment of the present invention, the information may be recorded on the recording layer comprising the organic dye compound (I) employing a short wavelength laser source such as a 405 nm blue laser source. The recording layer has good write characteristics and is compatible with the write-once storage medium. The recording layer has an excellent light fastness and light resistance, and better chemical and thermal stabilities.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 illustrates an UV/Visible/IR absorption spectrum of 4-nitro-cobalt complex cyanine dye of the present invention.

FIG. 2 illustrates a cross sectional view of a high density optical recording medium according to an embodiment of the present invention.

FIG. 3 illustrates a cross sectional view of a high density optical recording medium according to another embodiment of the present invention.

### DESCRIPTION OF THE INVENTION

It is to be understood that both the foregoing general description and the following detailed description are exemplary, and are intended to provide further explanation of the invention as claimed.

The present invention provides an organic dye compound for a recording layer suitable for implementing recording of information thereon by employing short wavelength laser source, and reproduction/playback of the recorded information. The organic dye compound (I) comprises the following general chemical structural formula:

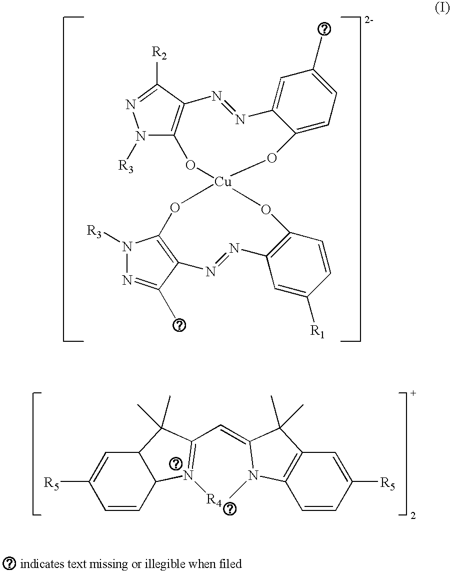

wherein R₁, R₂, R₃, R₄ and R₅ each independently represent H, alkyl, halide, nitro, benzyl group or substituted benzyl group. The organic dye compound (I) exhibits a maximum absorbance at a wavelength range of 400-550 nm.

According to an embodiment of the present invention, the anionic moiety of the organic dye compound (I) may enhance the chemical and thermal stabilities, light resistance and light fastness.

### SYNTHESIS EXAMPLES

### Embodiment 1

A reaction scheme of an example synthesis process for organic dye compound (I) is presented as follows.

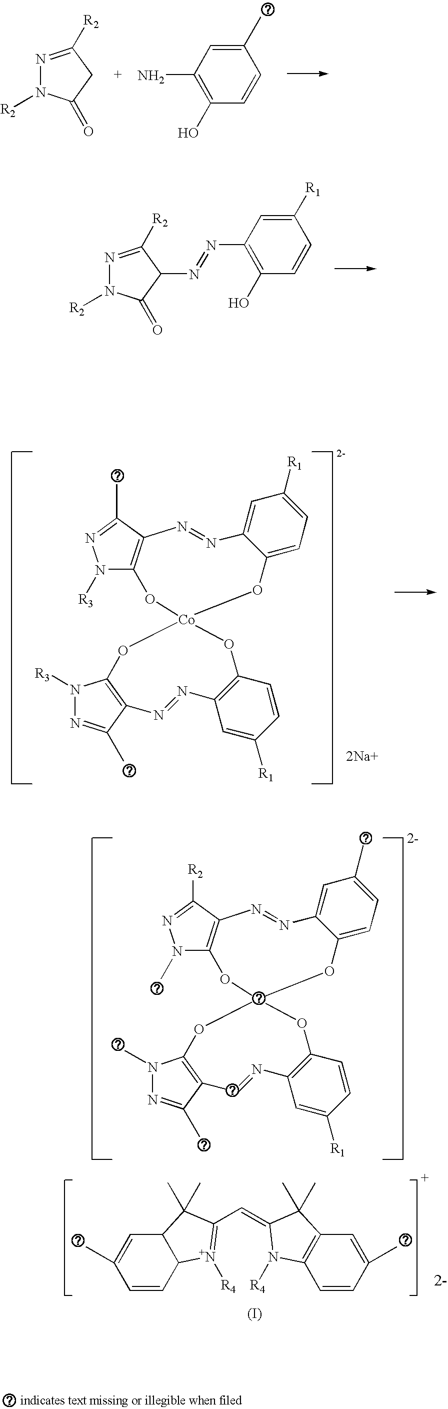

### Example 1

Synthesis of azo compound (1): 2.95 g (42.8 mmol) of sodium nitrite was added into 100 ml flask containing 50 ml of HCl and 6.39 g (35.67 mmol) of 2-amino-4-(1,1-dimethyl-propyl)-phenol. Next, the resulting mixture was stirred for 1 hour. Next, the resulting stirred mixture was slowly poured into a flask containing 5 g (35.67 mmol) of 2-methyl-5-propyl-2,4-dihydropyrazol-3-one in 60 ml alcohol. A yellowish-brown precipitate of azo compound (I) was formed, and the azo compound (I) was washed with water and then dried. Thus, 10.7 g of azo compound (1) with a yield of about 91% was obtained.

### Example 2

Synthesis of cobalt complex (2): 10 g of the above azo compound (I) was added into a 250 ml flask and then 5.09 g (62.04 mmol) of sodium acetate, 100 ml of alcohol, 40 ml of alcoholic, and 3.77 g (15.13 mmol) cobalt acetate were added into the flask. The resulting mixture was refluxed for 24 hours. Next, dichloromethane was added to the reaction mixture to obtain brown precipitate. The brown precipitate was washed with water and then dried with MgSO₄. Thus, 9.8 g of cobalt-complex (2) with a yield of 96% was obtained.

### Example 3

Synthesis of the organic dye compound (I-01): 3.33 g (4.91 mmol) of the above cobalt complex (2), 4.77 g (9.81 mmol) of cyanine (3) and 35 ml of alcohol were added into a 100 ml flask and then mixed well. Next, the resulting mixture was heated and refluxed for 24 hours. The resulting refluxed mixture evaporated out alcohol and 3.34 g of brown crystals of organic dye compound with a yield of 68.6% was obtained. The organic dye compound (I-01) has a λₘₐₓ=459 nm and ∈=55,170. The reaction scheme is presented as follows.

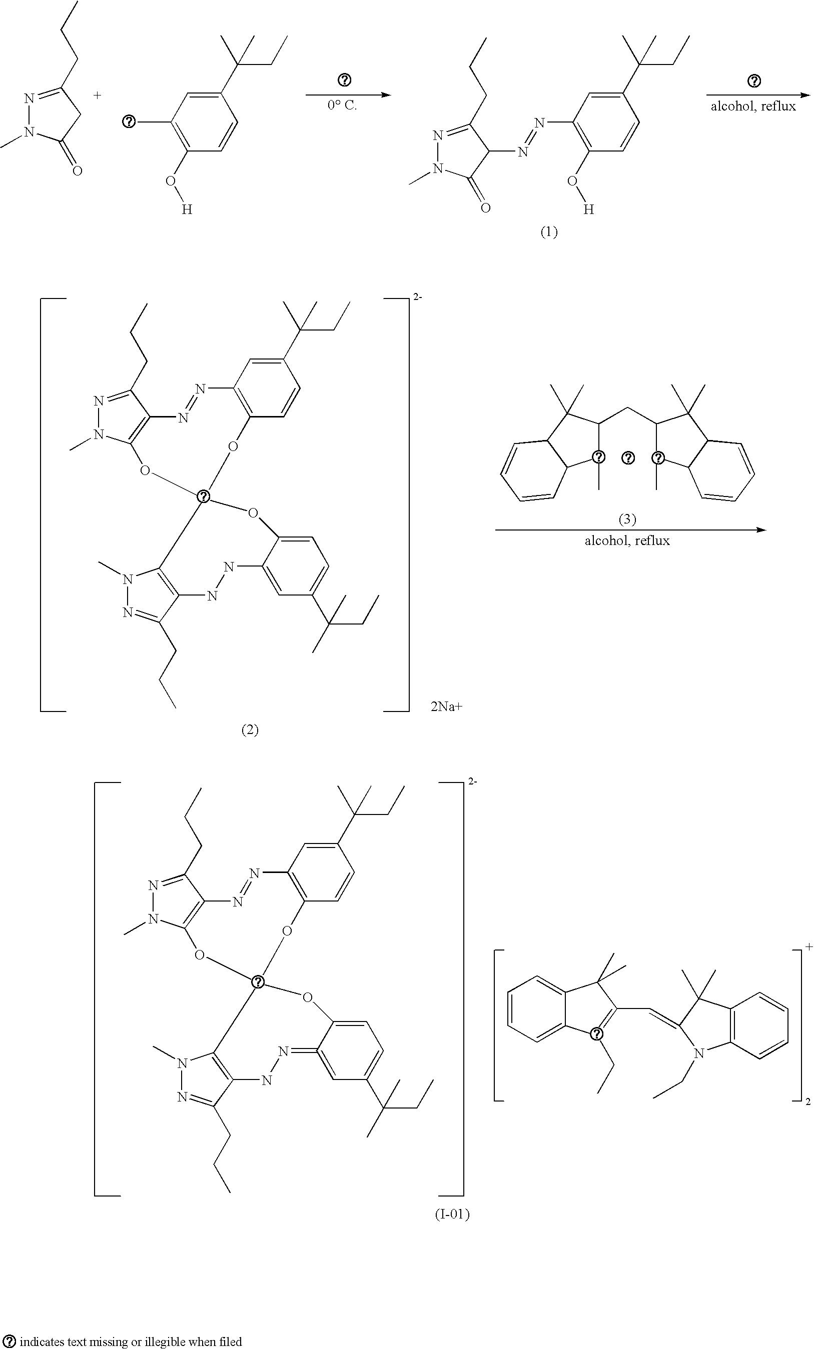

### Embodiment 2

Hereinafter, an example synthesis process for organic dye compound (I-02) is described.

### Example 4

Synthesis process for organic compound (5): the process steps of this example is identical to those of the example 1 except that the reactants used in this example includes 5.49 g (35.67 mmol) of 2-amino-4-nitro-phenol, 3.2 g (46.37 mmol) of NaNO₂ and 5 g (35.67 mmol) of 2-methyl-5-propyl-2,4-dihydro-pyrazol-3-one. Thus, 10.49 g of brown precipitate of organic compound (5) with a yield of 96% was obtained.

### Example 5

Synthesis of organic compound (6): the process steps of this example is identical to those of the example 2 except that the reactants used in this example includes 11.0 g (36.03 mmol) of organic compound (5), 4.49 g (18.02 mmol) of cobalt acetate, 6.06 g (73.86 mmol) of NaOAc and 110 ml of alcohol. Thus, 10.75 g of brown precipitate of organic compound (6) with a yield of 84% was obtained.

### Example 6

Synthesis process for the organic dye compound (I-02) is described. The process steps of this example is identical to those of the example 3 except that the reactants used in this example includes 3.5 g (4.91 mmol) of organic compound (6), 4.77 g (9.81 mmol) of cyanine complex (3) and 35 ml alcohol. Thus, 2.95 g of organic dye compound (I-02) with a yield of 58% was obtained. The organic dye compound (I-02) has λₘₐₓ=457 nm and ∈=61,602.

The reaction scheme of synthesis of the organic dye compound (I-02) is presented as follows.

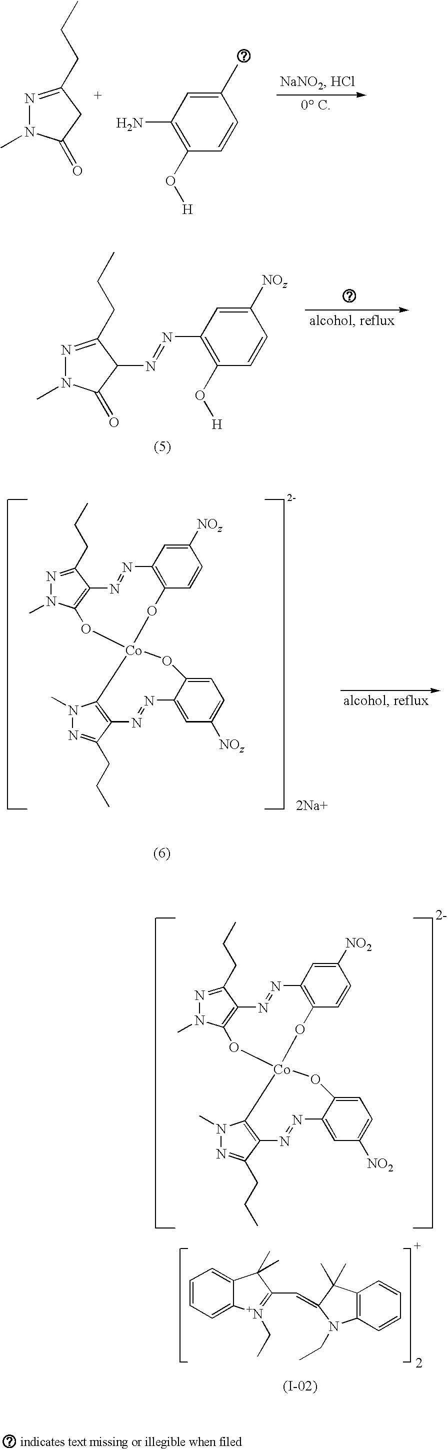

Preferred examples of the organic dye compound (I) are shown below.

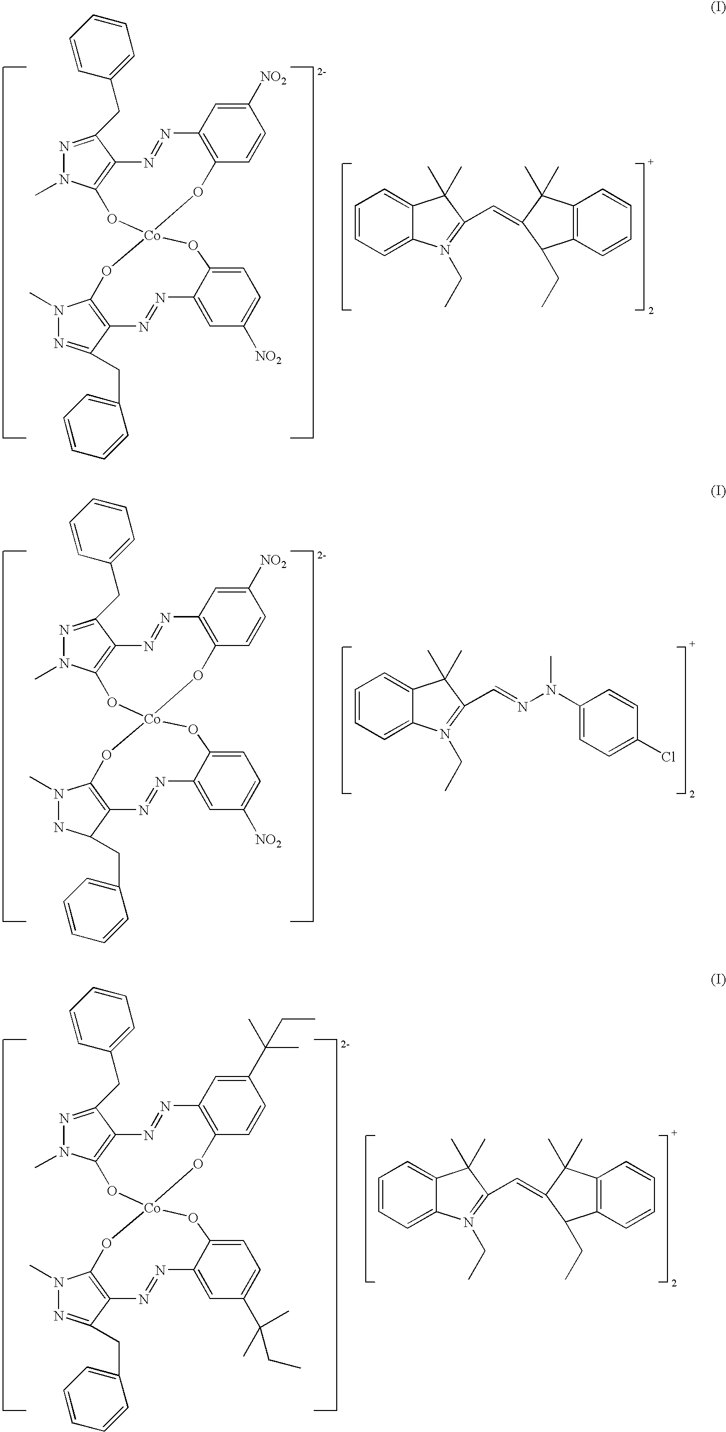

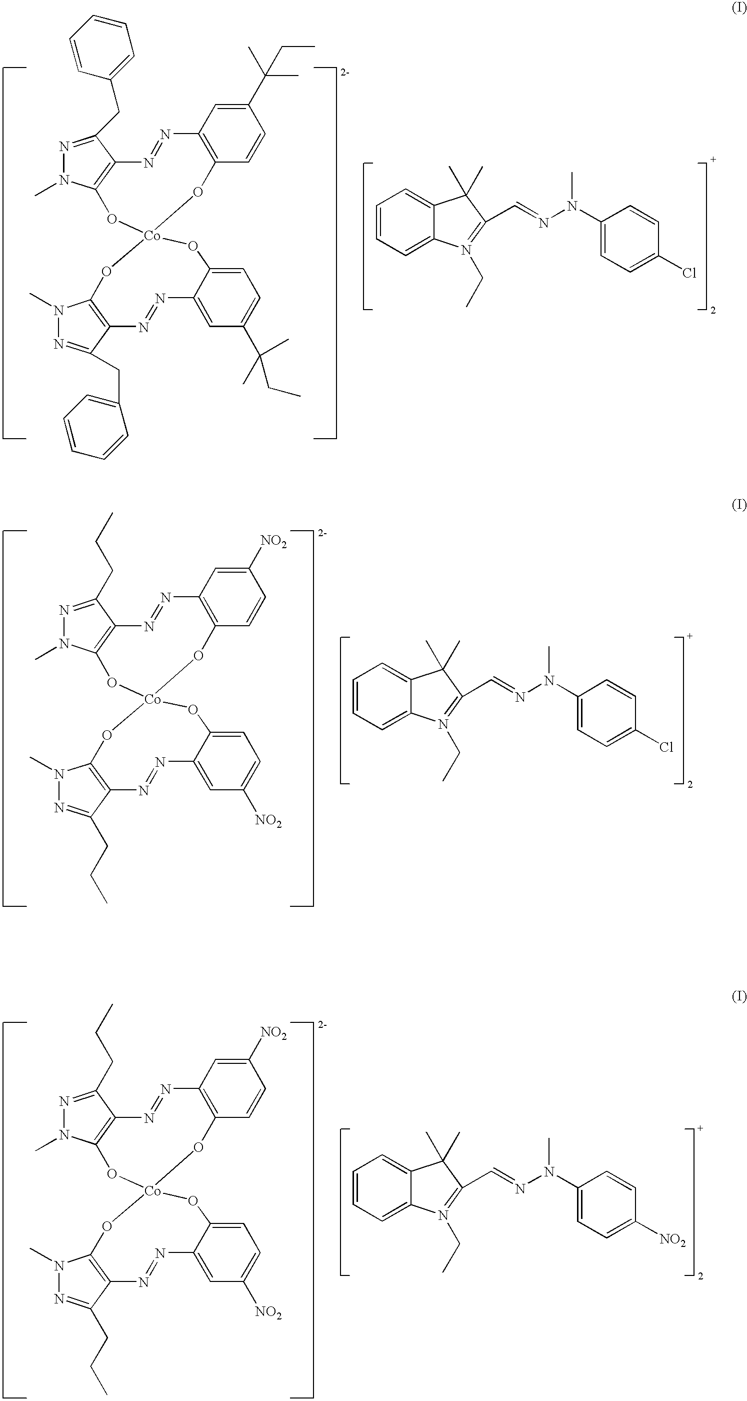

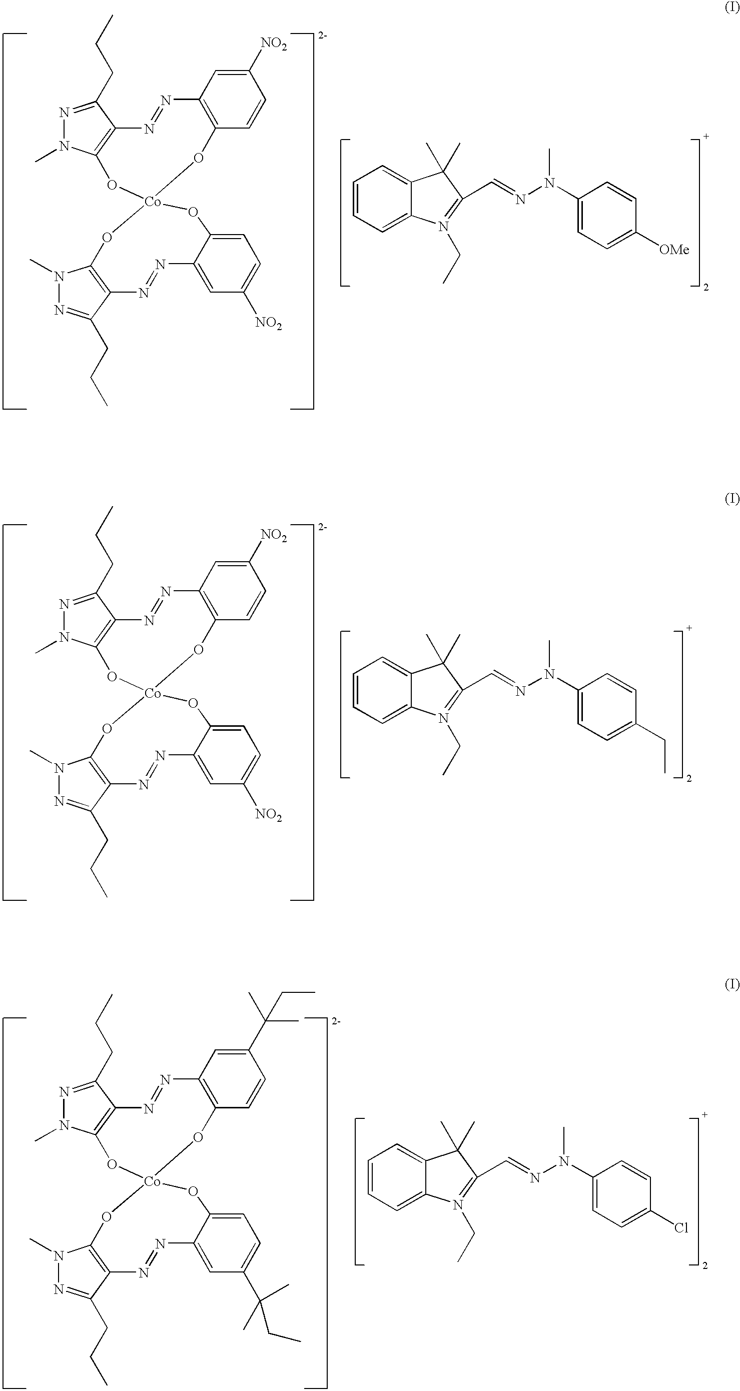

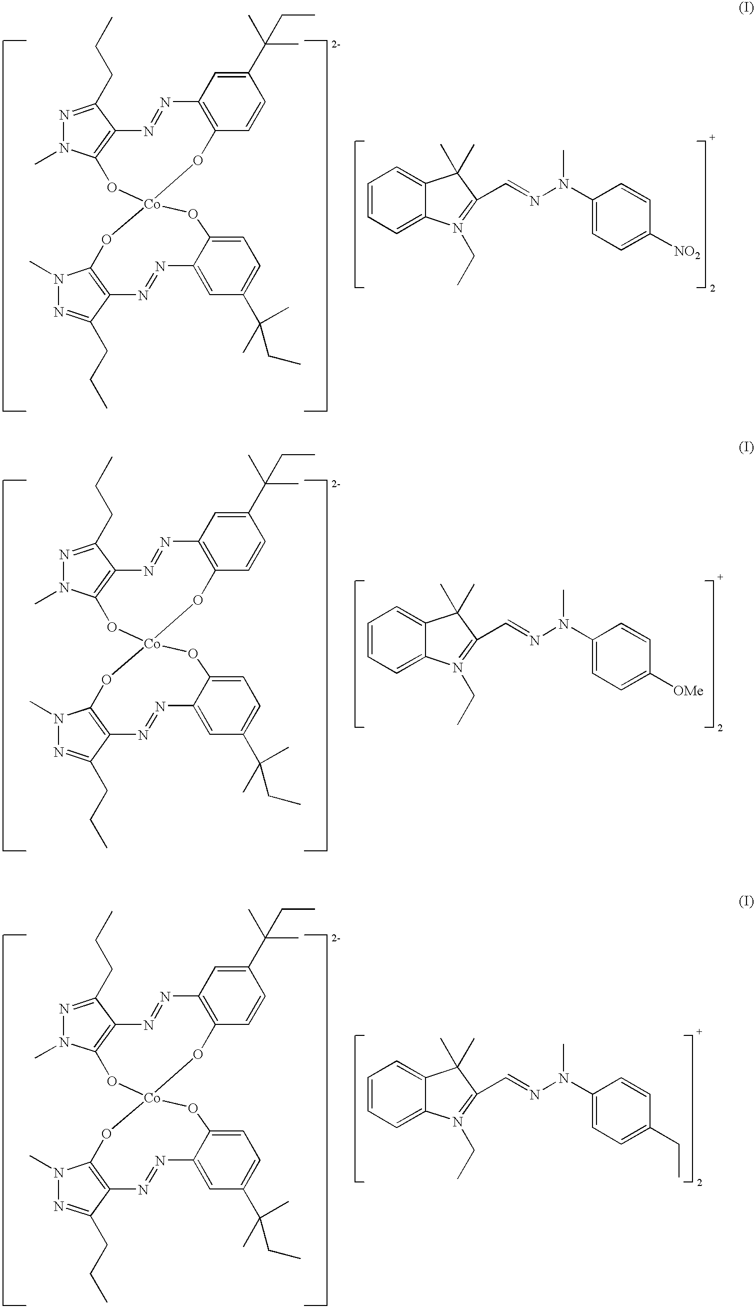

### Table

The following table shows various organic dye compound and their respective maximum absorbance and extinction co-efficient measured using absorption spectroscopy.

| | | Extinction |
|---|---|---|
| | λ_{abs.} | co-efficient |
| Compound | (nm) | (ε) |
| 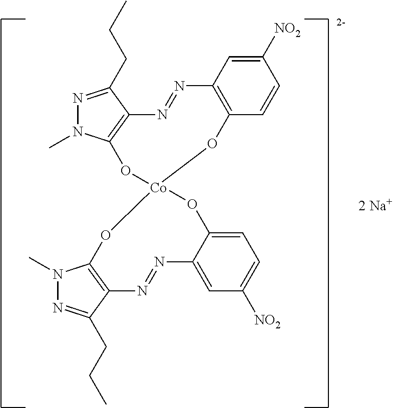 | 463 | 31,734 |
| 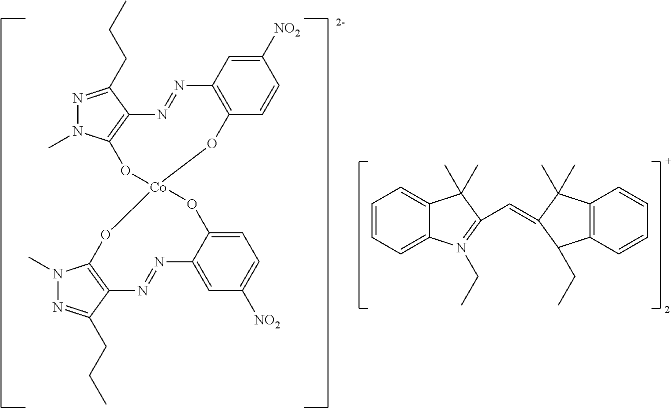 | 457 | 61,602 |
| 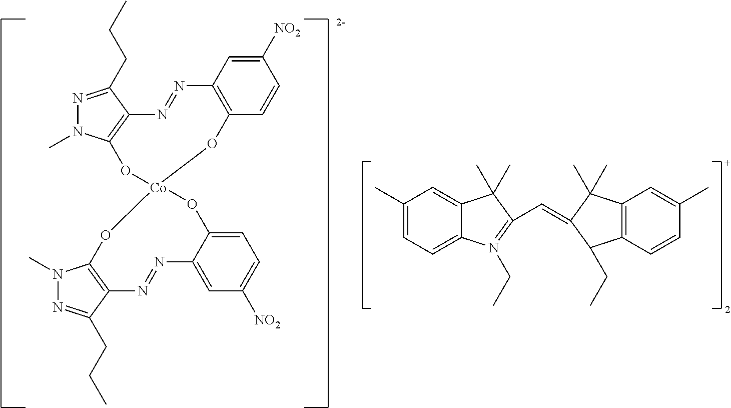 | 459 | 55,170 |
| 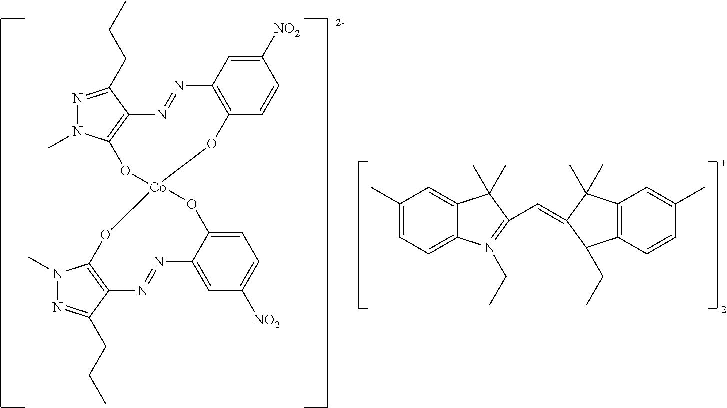 | 460 | — |
| 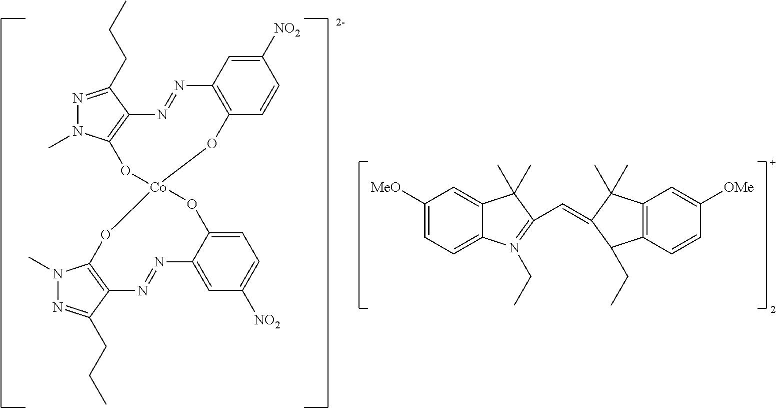 | 463 | 67,418 |
| 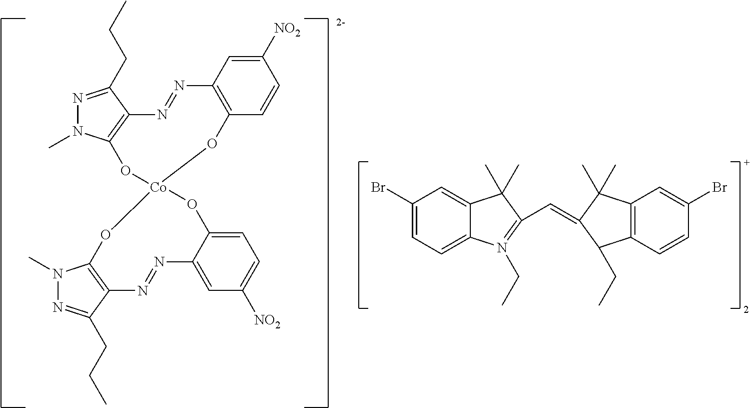 | 468 | — |

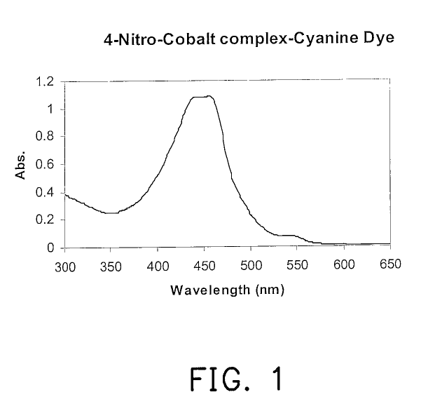

FIG. 1 illustrates an UV/Visible/IR absorption spectrum of 4-nitro-cobalt complex cyanine dye of the present invention.

Information may be recorded on the recording layer comprising the organic dye compound (I) with good write characteristics and compatible with the write-once storage medium.

### Application Example 1

### HD DVD-R Recording Medium

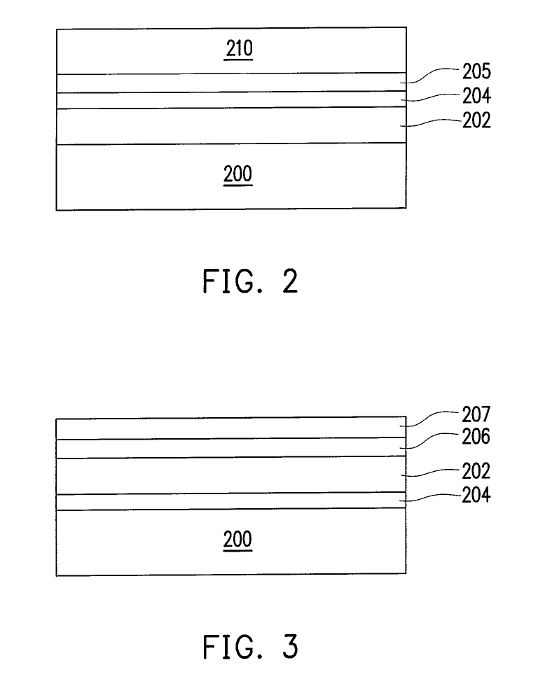

Hereinafter, a structure of a high density HD DVD-R recording medium according to an embodiment of the present invention will be described with reference to FIG. 2 as follows. Referring to FIG. 2, the HD DVD-R optical recording medium comprises a first substrate 200, a recording layer 202 including an organic dye compound (I) of the present invention described above, a reflective layer 204, a bonding layer 205 and a second substrate 210. The recording layer 202 is disposed over the first substrate 200. The reflective layer 204 is disposed over the recording layer 202. The second substrate 210 is disposed over the reflective layer 204 with a bonding layer 205. The material of the bonding layer 205 may be comprised of, for example but not limited to, an ultraviolet curable acryl resin or a silicon type hard coating agent.

### Application Example 2

### HD-Blue-Ray-R Recording Medium

Hereinafter, a structure of a high density blue-ray-R recording medium according to another embodiment of the present invention will be described with reference to FIG. 3 as follows. Referring to FIG. 3, the high density blue-ray-R optical recording medium comprises a first substrate 200, a reflective layer 204, a recording layer 202 including an organic dye compound (I) of the present invention described above, a dielectric layer 206 and a cover layer 207. The reflective layer 204 is disposed over the first substrate 200. The recording layer 202 is disposed over the reflective layer 204. The dielectric layer 206 is disposed over the recording layer 202. The cover layer 207 is disposed over dielectric layer 206.

According to an embodiment of the present invention, the first substrate 200, the second substrate 210 and the cover layer 207 are preferably transparent to the laser beam. The material of the first substrate 200, the second substrate 210 and the cover layer 207 may be comprised of, for example but not limited to, glass or plastic materials. From various aspects, the plastic material is preferably used. The plastic material may be comprised of, for example but not limited to, polycarbonate (PC), polymethylmethacrylate (PMMA), polymer resins, glass, acryl resin, methacryl resin, vinyl acetate resin, vinyl chloride resin, nitro cellulose, polyethylene resin, polypropylene resin, polycarbonate resin, polyimide resin, epoxy resin, polysulfone resin metallocene based cyclic olefin copolymer (mCOC) or UV curing materials. Among the plastic materials mentioned above, an injection molded polycarbonate resin substrate may of particular interest from the viewpoint of the high productivity, low cost and moisture resistance. The thickness of the first substrate 200 may be between 0.5 mm to 1.3 mm, more preferably about 0.6 mm. The first substrate 200, for example, comprises lands, or pre-curved pits or grooves with a track pitch of less than 0.4 μm. The lands, or pre-curved pits or grooves in the first substrate 200 are used to provide a signal surface for the laser tracking of the pick-up head of the laser.

According to an embodiment of the present invention, the recording layer 202 of the present invention including an organic dye compound (I) is formed with a thickness in a range of about 0.6 mm. The recording layer 202 may be formed by employing well known thin-film-forming methods such as a spin coating method, a roller press method, a vacuum vapor deposition method, a sputtering method, a doctor blade method, a casting method, inkjet printing method or a dipping method. However, the spin coating method is preferred from the viewpoint of the productivity and cost. A 1.5 Wt. % solution of the organic dye compound (I) of the present invention in 2,2,3,3-tetrafluoropropanol may be prepared and used for spin coating the thin film recording layer 202. It should also be noted that other solvents such as alcohol, ketone, ether, chloroform or dichloromethane may also be used to make the dye solution for forming the thin film recording layer 202. Preferred examples of alcohol include 2,2,3,3-tetrafluoropropanol, methanol, ethanol, isopropanol, diacetonalchol (DAA), ether alcohol, trichloroethanol, 2-chloroethanol, octafluoropentanol or hexafluorobutanol. Preferred examples of ketone include acetone methyl isobutyl ketone (MIBK) or dimethylethyl ketone (MEK). Preferred examples of ether include ethyl ether, propylene glycol monoethyl ether or tetrahydrofuran. Still other solvents such as propylene glycol monoethyl acetate, 3-hydroxy-3-methyl-2-butanone, chloroform, dichloromethane, 1-chlorobutane, dimethylformamide (DMF), dimethylacetamide (DMA), methylcyclohexane (MCH), chitin, cellulose ester, nitrocellulose, cellulose acetate, cellulose acetate butyrate, polyvinyl butyral may also be used for preparing the solution of organic dye compound (I).

According to an embodiment of the present invention, the reflective layer 204 may be comprised of, for example but not limited to, metals such as gold, silver, copper, aluminum or platinum, titanium or alloys thereof, or equivalents thereof, which have high reflectance in the laser wavelength region to be employed. The reflective layer 204 may be formed using vacuum sputtering.

The dielectric layer 206 may be comprised of, for example but not limited to, ZnS—SiO₂, ZnS, AlN, SiN or SiC. The cover layer 207 may be comprised of, for example but not limited to, UV curing materials or plastic materials. The cover layer 207 may be formed by spin coating, screen printing, thermal gluing or roller pressing.

The recording layer 202 of the optical recording medium of the present invention may be formed on one side of the first substrate 200. According to an embodiment of the present invention, multiple recording layers 202 may be also used for fabricating a multi-layer stacked optical recording medium structure with a view of further increasing the storage capacity of the optical recording medium.

Accordingly, the information may be recorded on the recording layer comprising the organic dye compound (I) of the present invention with a good write characteristics, and the compatibility with the write-once storage medium may be retained.

According to an embodiment of the present invention, the recording layer comprising the organic dye compound (I) exhibits absorption at wavelength within a range of 400 to 550 nm, and exhibit excellent recording properties, such as light resistance, light fastness, chemical and thermal stabilities. Accordingly, it is possible to record information on the recording layer employing a short wavelength laser source such as a 405 nm blue laser source.

It will be apparent to those skilled in the art that various modifications and variations can be made to the structure of the present invention without departing from the scope or spirit of the invention. In view of the foregoing, it is intended that the present invention covers modifications and variations of this invention provided they fall within the scope of the following claims and their equivalents.

What is claimed is:

1. An organic dye compound (I) comprising a following general chemical structural formula: 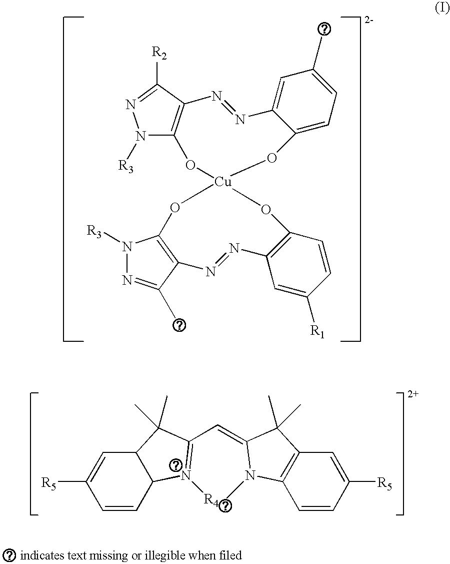
wherein R₁, R₂, R₃, R₄ and R₅ each independently represent H, alkyl, halide, nitro, benzyl group or substituted benzyl group; and wherein the organic dye compound (I) exhibits a maximum absorbance at a wavelength range of 400-550 nm.

2. The organic dye compound (I) of claim 1, wherein the organic dye compound (I) comprises a following chemical structural formula:

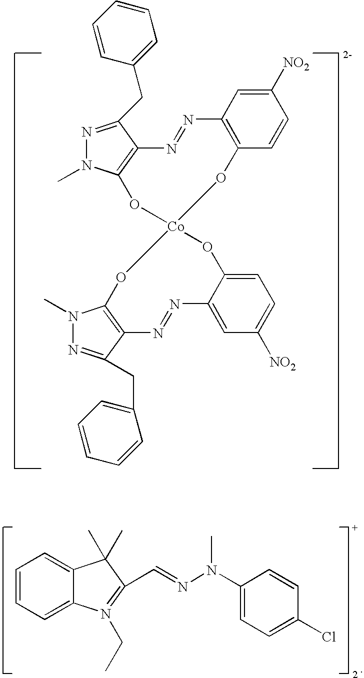

3. The organic dye compound (I) of claim 1, wherein the organic dye compound (I) comprises a following chemical structural formula:

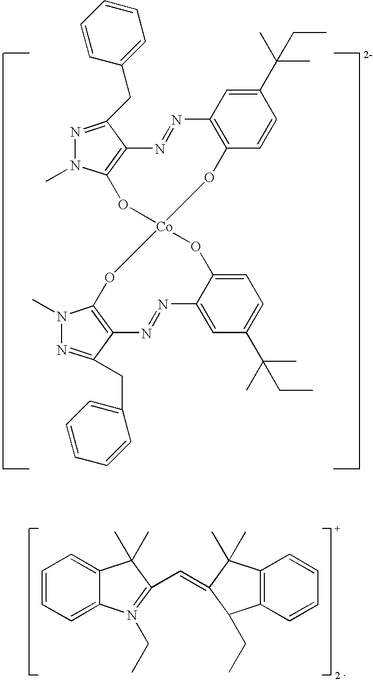

4. The organic dye compound (I) of claim 1, wherein the organic dye compound (I) comprises a following chemical structural formula:

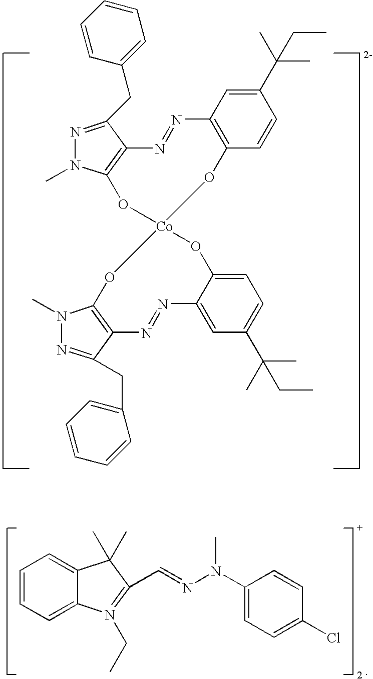

5. The organic dye compound (I) of claim 1, wherein the organic dye compound (I) comprises a following chemical structural formula:

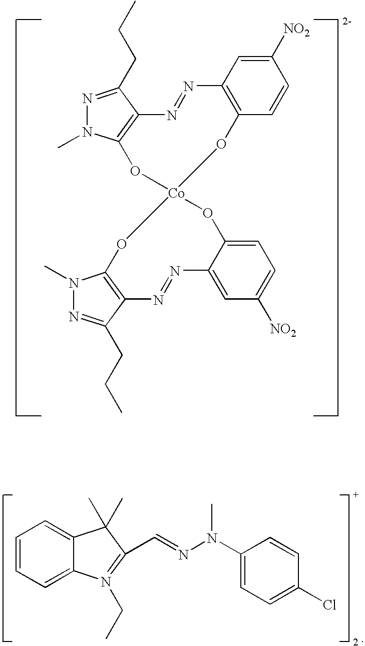

6. The organic dye compound (I) of claim 1, wherein the organic dye compound (I) comprises a following chemical structural formula:

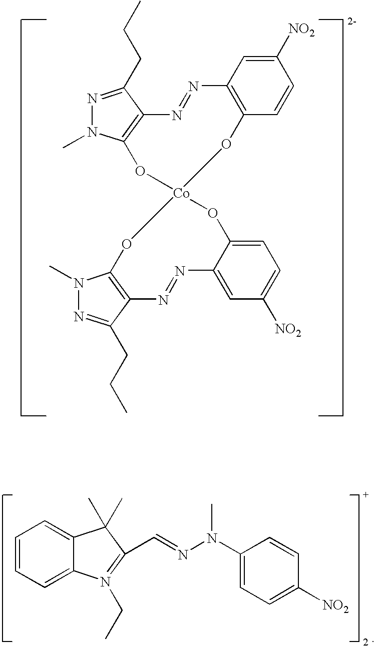

7. The organic dye compound (I) of claim 1, wherein the organic dye compound (I) comprises a following chemical structural formula:

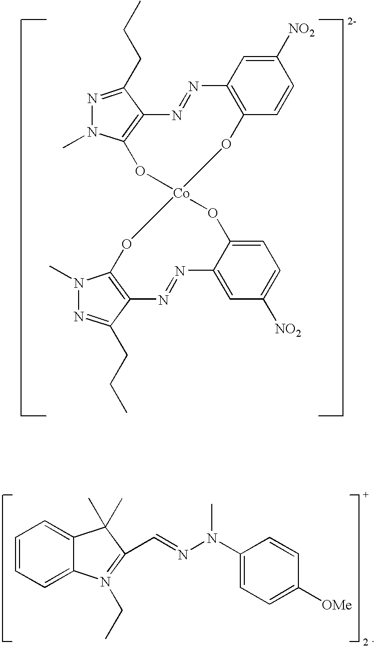

8. The organic dye compound (I) of claim 1, wherein the organic dye compound (I) comprises a following chemical structural formula:

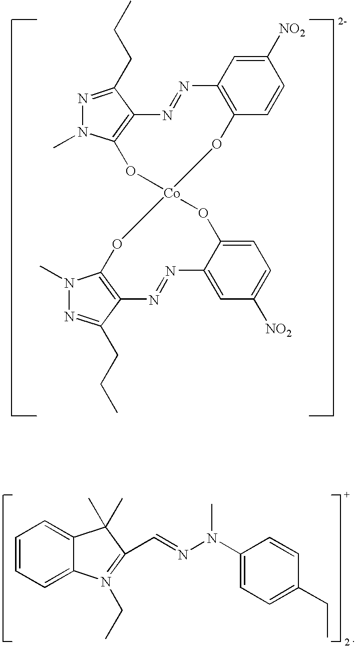

9. The organic dye compound (I) of claim 1, wherein the organic dye compound (I) comprises a following chemical structural formula:

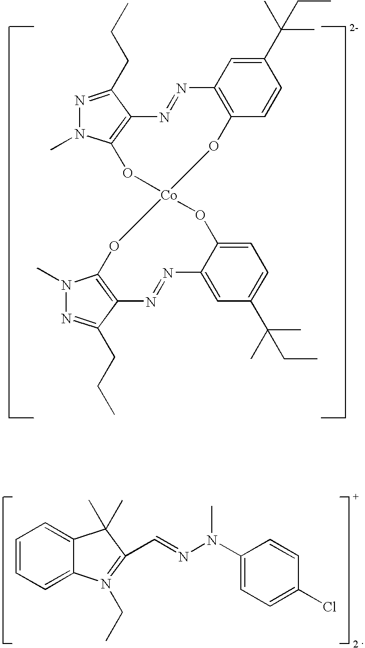

10. The organic dye compound (I) of claim 1, wherein the organic dye cornpound (I) comprises a following chemical structural formula:

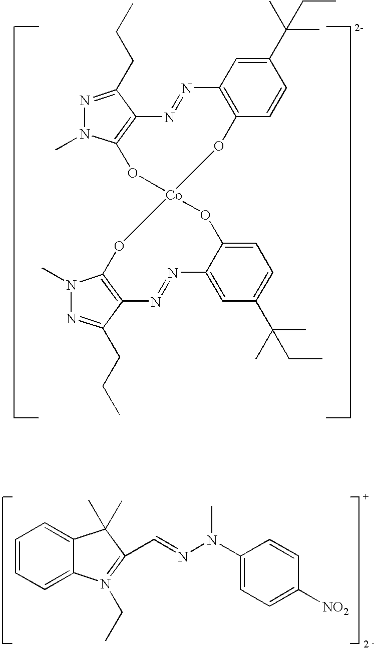

11. The organic dye compound (I) of claim 1, wherein the organic dye compound (I) comprises a following chemical structural formula:

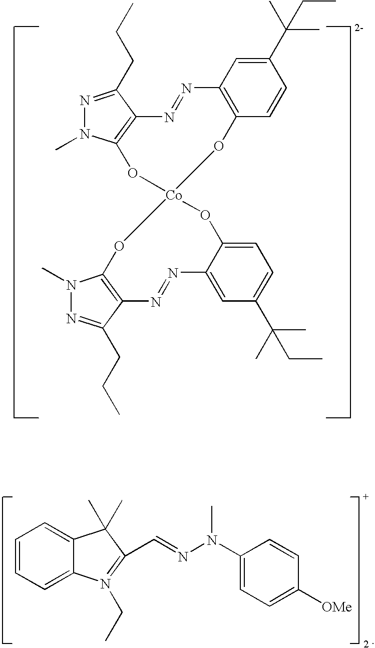

12. The organic dye compound (I) of claim 1, wherein the organic dye compound (I) comprises a following chemical structural formula:

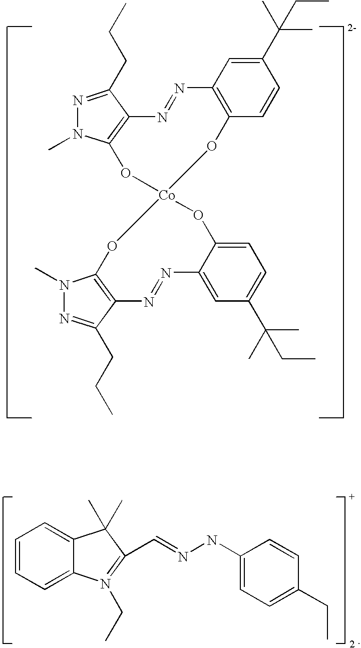

13. A high-density optical recording medium, comprising:
a first substrate;
a recording layer, disposed over the first substrate, comprising an organic dye compound including at least an organic dye compound (I) comprising a following general chemical structural formula: 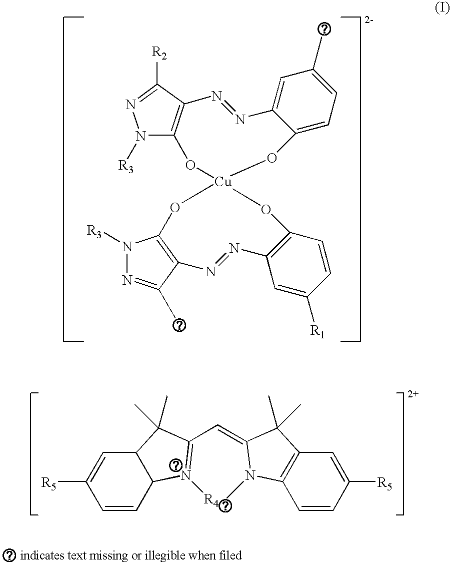
wherein R₁, R₂, R₃, R₄ and R₅ each independently represent H, alkyl, halide, nitro, benzyl group or substituted benzyl group; and wherein the organic dye compound (I) exhibits a maximum absorbance at a wavelength range of 400-550 nm;
a reflective layer, disposed over the recording layer; and
a second substrate, disposed over the reflective layer.

14. The high-density optical recording medium of claim 13, wherein a thickness of the first and second substrates is about 0.6 mm, and the first and second substrates comprises a material selected from the group consisting of polycarbonate (PC), polymethylmethacrylate (PMMA), polymer resins, glass, acryl resin, methacryl resin, vinyl acetate resin, vinyl chloride resin, nitro cellulose, polyethylene resin, polypropylene resin, polycarbonate resin, polyimide resin, epoxy resin, polysulfone resin and metallocene based cyclic olefin copolymer (mCOC).

15. The high-density optical recording medium of claim 13, wherein the first substrate comprises a land-and-groove surface on a single side thereof.

16. The high-density optical recording medium of claim 13, wherein the reflective layer comprises a material selected from the group consisting of gold, silver, copper, aluminum, platinum, titanium and alloys thereof.

17. The high-density optical recording medium of claim 13, further comprising a bonding layer disposed between the second substrate and the reflective layer, wherein a material of the bonding layer comprises an ultraviolet curable acryl resin or a silicon type hard coating agent.

18. A high-density optical recording medium, comprising:
a substrate;
a reflective layer, disposed over the substrate;
a recording layer, disposed over the reflective layer, comprising an organic dye compound including at least an organic dye compound (I) comprising a following general chemical structural formula: 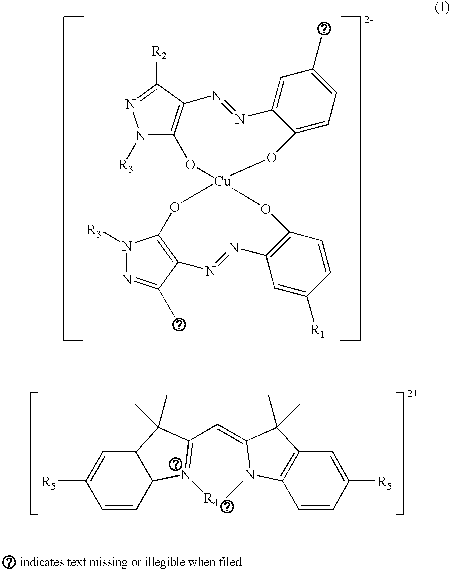
wherein R₁, R₂, R₃, R₄ and R₅ each independently represent H, alkyl, halide, nitro, benzyl group or substituted benzyl group; and wherein the organic dye compound (I) exhibits a maximum absorbance at a wavelength range of 400-550 nm; and
a cover layer, disposed over the recording layer.

19. The high-density optical recording medium of claim 18, wherein a thickness of the substrate is about 0.6 mm, and wherein the substrate comprises a material selected from the group consisting of polycarbonate (PC), polymethylmethacrylate (PMMA), polymer resins, glass, acryl resin, methacryl resin, vinyl acetate resin, vinyl chloride resin, nitro cellulose, polyethylene resin, polypropylene resin, polycarbonate resin, polyimide resin, epoxy resin, polysulfone resin and metallocene based cyclic olefin copolymer (mCOC).

20. The high-density optical recording medium of claim 18, wherein the substrate comprises a land-and-groove surface on a single side thereof.
